(19) United States
(12) Patent Application Publication
(10) Pub. No.: US 2018/0091051 A1
(43) Pub. Date: Mar. 29, 2018

(54) Control and Detection of Average Phase Current in Switching DC-DC Power Converters

(71) Applicant: Apple Inc., Cupertino, CA (US)

(72) Inventors: Jamie L. Langlinais, San Francisco, CA (US); Di Zhao, Santa Clara, CA (US)

(21) Appl. No.: 15/441,731

(22) Filed: Feb. 24, 2017

Related U.S. Application Data
(60) Provisional application No. 62/398,966, filed on Sep. 23, 2016.

(51) Int. Cl. H02M 3/158; H02M 1/08

(52) U.S. Cl. CPC H02M 3/158; H02M 2001/0009; H02M 1/08

(57) ABSTRACT

A method for dc-dc power conversion using a switching phase. While a high side switch of the phase is closed, detecting that a high side current of the phase has risen to a set peak limit, and in response opening the high side switch. While the high side switch is open, preventing the high side switch from closing so long as a valley limit reached condition has not been detected, wherein the valley limit reached condition is detected when a low side current of the phase has dropped to a set valley limit. Other embodiments are also described and claimed.

This patent application claims the benefit of the earlier filing date of U.S. Provisional Application No. 62/398,966 filed Sep. 23, 2016.

### FIELD

Embodiments of the invention relate to techniques for controlling an average phase current, and for detecting an average phase current, in a switching dc-dc power converter.

### BACKGROUND

Power supply requirements for mobile applications are trending towards greater output power and smaller physical designs. For switching dc-dc power converters, this has translated to converters that have lower phase inductance, higher phase current switching frequencies, and smaller thermal footprints. Additionally, tighter current limits for various components are desired, in order to consistently operate them closer to their maximum rated dc current or thermal limit. For example, to ensure that the selected inductors (phases) are no larger than needed (so as to make efficient use of the volume inside a smartphone, for example), the phase currents (inductor currents) should be controlled so that they come close to but do not exceed the dc rated currents of those inductors. Current mode control is a popular technique, especially in a buck converter design. It is typically implemented as either peak mode control, or valley mode control.

### SUMMARY

Attempting to limit the average current (through a phase) by relying on detected peak limits or valley limits is not sufficiently accurate to meet the tight tolerance needed for certain mobile applications of a dc-dc switching power converter. Accurate average current detection and average current control are needed so as to enable the converter to operate closer to the ratings of its components, thereby helping increase the power that it can deliver to its load while avoiding component failures. The term average is used here to refer to any suitable measure of the central tendency (e.g., mean, RMS) of a variable (here, phase current.)

In accordance with an embodiment of the invention, a method for dc-dc power conversion includes the following operations while phase current is being switched, in order to control the average phase current or maintain a dc level of the phase current. While a high side switch of the phase is closed, a high side current of the phase is detected when it has risen to a set peak limit, and in response the high side switch is opened (and optionally, if there is a low side switch, the low side switch is closed) so that the phase current is routed through the low side. Then, while the high side switch is open and the phase current is circulating through the low side, the high side switch is prevented from closing so long as a valley limit reached condition has not been detected. The valley limit reached condition is detected when a low side current of the phase has dropped to a set valley limit. In this manner, where both the peak and valley limits are being used to control when the high side switch is opened and to then prevent the high side switch from closing, an average current through the phase is accurately controlled, for example to be no more than the average of the set peak limit and the set valley limit. In other words, setting the peak limit and the valley limit in this method will cause the phase current to exhibit an average value that is equal to the average of the set peak and valley limits (within practical tolerances, of course), so that accurate control of average phase current is achieved.

In accordance with another aspect of the invention, a method for detecting an average of a switching phase current in a dc-dc power converter includes the following operations. A signal that represents current through a low side/a high side (not both simultaneously) of a phase is averaged over several switching cycles of the phase, while only the low side/the high side is conducting phase current of the phase. The averaged signal is held constant while the low side/the high side is not conducting the phase current, but after a few switching cycles the averaged signal stabilizes and accurately represents the average phase current. This technique may have several advantages including implementation cost, accuracy, and flexibility.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, in the interest of conciseness and reducing the total number of figures, a given figure may be used to illustrate the features of more than one embodiment of the invention, and not all elements in the figure may be required for a given embodiment.

FIG. 1 is a combined block diagram and circuit schematic illustrating part of a dc-dc switching power converter.

FIG. 2 is a graph of several waveforms during an example operation of the circuit of FIG. 1.

FIG. 3 is a combined block diagram and circuit schematic illustrating part of another dc-dc switching power converter.

FIG. 4 is a top graph showing phase current, average phase current and low side current of a switching dc-dc power converter, and bottom graph showing an averaged signal in relation to the low side current.

### DETAILED DESCRIPTION

Several embodiments of the invention with reference to the appended drawings are now explained. Whenever the shapes, relative positions and other aspects of the parts described in the embodiments are not explicitly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

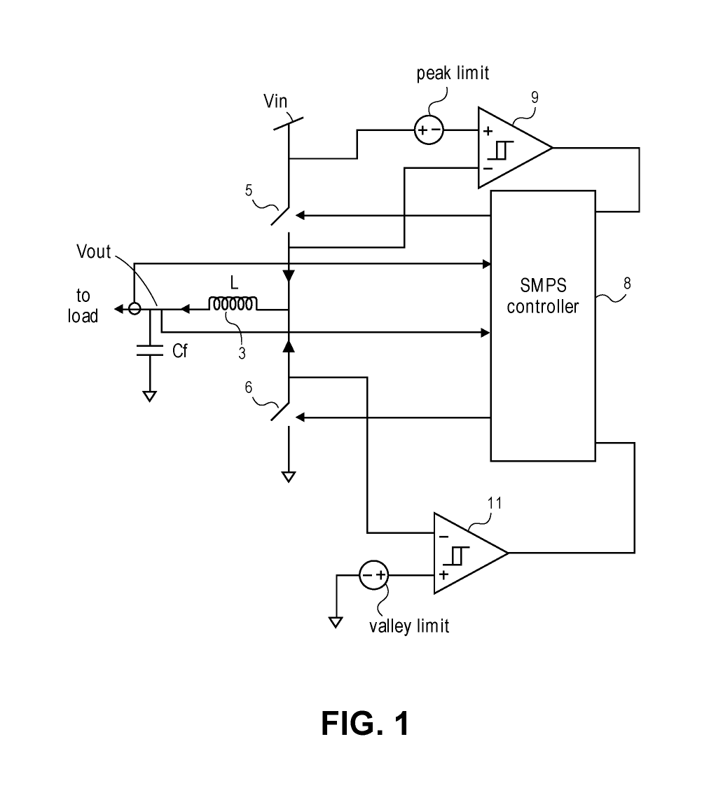

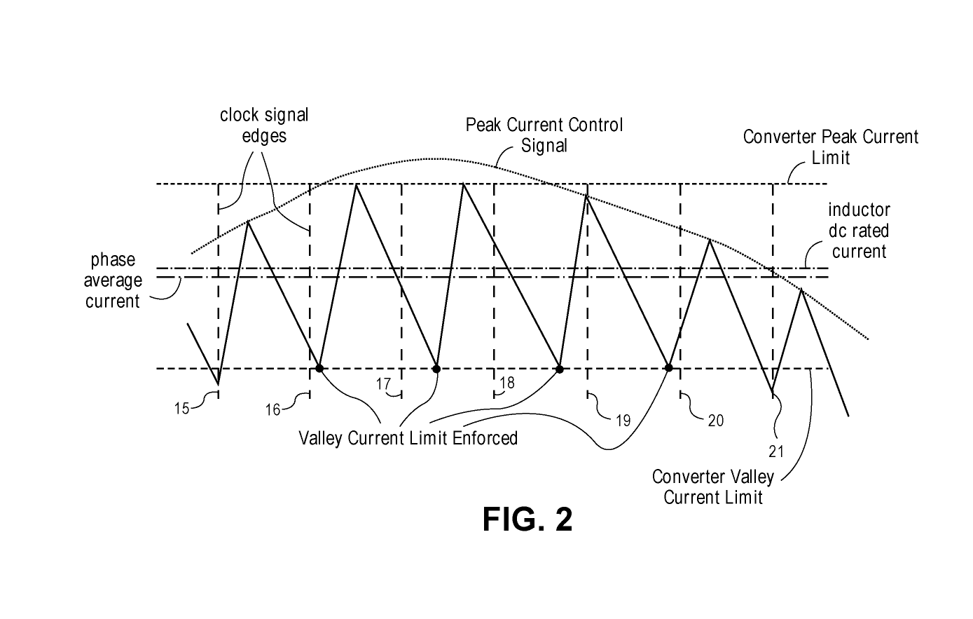

FIG. 1 is a combined block diagram and circuit schematic illustrating part of a dc-dc switching power converter. The converter depicted in FIG. 1 is an example of a circuit that can perform a method for dc-dc power conversion using a switching phase 3 that has an inductance L that serves to transfer energy between an input (having a voltage Vin) and an output (having a voltage Vout.) The terms “phase” and “inductor” are used interchangeably. The phase current is indicated by the arrow adjacent to the inductance symbol, and is directed into the output to which a filter capacitor Cf is coupled, the latter serving to reduce ripple voltage in Vout. A switching cycle of the phase may be defined as a time interval during which the phase current is falling, because a high side 5 is “off” (a high side switch is open), and an adjoining time interval during which the phase current is rising, because the high side 5 is “on” (the high side switch is closed.) As seen in the waveform shown in FIG. 2, the switching phase current rises, then falls, then rises, then falls, etc. as a triangular waveform.

Returning to FIG. 1, control of the switches in the high side 5 and the low side 6 is may be in accordance with any conventional switch mode power supply (SMPS) dc-dc power conversion techniques, e.g., buck conversion using pulse width modulation (PWM) based, feedback control algorithms. Such techniques may be implemented within an SMPS controller 8 (e.g., which may be implemented using any suitable combination of hardwired logic circuits, state machines, programmed microprocessor and analog signal conditioning circuitry), and which has the needed circuitry that can vary for example the frequency at which the switches in the high side 5 and low side 6 are switched, or the pulse width (ON time and OFF time) of the switches, so as to reduce an error signal. The error signal may be a difference between a measured Vout (a feedback voltage taken from the output of the SMPS) and a reference voltage (e.g., as part of a voltage regulation control loop), or it may be a difference between a detected load current and a reference load current. Note that while FIG. 1 shows a single phase whose far end is coupled to the output node (Vout) which is filtered by Cf and feeds a load, the description here is equally applicable to a multi-phase converter that has two or more phases whose far ends are coupled to the same output node (Vout), on a per-phase basis.

Now, describing further details of the circuit in FIG. 1, it should first be understood that this circuit is just an example of how to control the average phase current; other circuit designs that can achieve the following control process may be possible. While the high side switch (high side 5) of the phase 3 is closed, a high side current of the phase 3 (the current being indicated by the arrow symbol that is just below the switch symbol for high side 5) rises. Once the high side current has risen to a set peak limit, it is detected by a peak comparator 9 and in response to which the SMPS controller 8 signals the switch of the high side 5 to open. Then, while the high side 5 switch is open, the high side 5 switch is prevented from closing so long as a valley limit reached condition has not been detected. The valley limit reached condition is detected when a low side current of the phase 3, indicated by the arrow symbol just above the switch of the low side 6, has dropped to a set valley limit (as detected by a valley comparator 11.) In the example shown, each of the high side and low side currents is detected by comparing a sensed voltage across the respective switch whose on-resistance (e.g., Rds(on) of a field effect transistor, FET, switch) may be known; alternatively, a dedicated sense resistor may be used. The reference inputs of the analog comparators 9, 11 may be coupled to fixed or programmable voltage sources that set a peak limit (threshold voltage) and a valley limit (threshold voltage), respectively, on the non-inverting (positive) inputs of their respective comparators, while the inverting inputs are coupled to receive a voltage from the high side 5 and the low side 6, respectively, as shown. Note that other circuit designs for a current detector are possible that can compare a high side or low side current of a phase, with a set peak or valley limit, respectively. The circuit in FIG. 1 may ensure that an average current (through the phase 3) is no more than the average of the set peak limit and the set valley limit.

FIG. 2 is a graph of several waveforms during an example operation of the circuit of FIG. 1. The switching phase current is a triangular waveform, a top horizontal line is the peak current limit (for the given phase), corresponding to the peak limit in FIG. 1, and a bottom horizontal line is the valley current limit (for the given phase), corresponding to the valley limit in FIG. 1. At the midpoint between the top and bottom horizontal lines is the average phase current, which in this case has been set (by appropriate programming of the peak and valley limits) to be just below the dc rated current of the inductance L of the phase 3. This means that the average current (in the phase), during operation of the dc-dc power converter, has been limited, as this action over-rides other control loops that may be running in the SMPS controller 8 and that are attempting to adjust how the high side 5 and the low side 6 are switched in order to increase power output to the load. As an example, an average current limit (of the phase 3) may be set to be no more than 10% lower than a dc rated current of an inductor of the phase 3, so as not to exceed the rating of the inductor and therefor reduce the possibility of failure of the inductor.

Referring back to FIG. 2, another way to view the process described above is that the SMPS controller 8 (see FIG. 1) allows the converter to operate under a typical, peak-only mode, or a valley-only mode, while under “normal” operation, until the load increases to a point that causes the SMPS controller 8 to then enforce a constant ripple current (having a predetermined dc level, that may be the average of a predetermined, fixed peak and a predetermined, fixed valley.) This is shown in FIG. 2, where a Peak Current Control Signal is depicted that represents the real-time variation of the load. The signal may be generated by the SMPS controller 8 (see FIG. 1) based on sensing the load current or sensing the output (load) voltage, and then averaging to smooth out the variations. During normal operation when the Peak Current Control Signal is below some threshold, the initial downward excursion of the phase current just before clock edge 15 does not trigger enforcement of the valley limit. But when the average current is high enough, here, between clock edges 15, 16 as detected by, for example, comparing the Peak Current Control Signal to a predetermined threshold, the valley limits start to be enforced. This is shown in FIG. 2, where phase current ripple is constant during the three consecutive current switching cycles represented by the four points where the valley current limit is enforced: i) between clock edges 16, 17; ii) between clock edges 17, 18; iii) between clock edges 18, 19; and iv) between clock edges 19, 20. Thereafter, when the load drops to below a predetermined level (between clock edges 20, 21 as detected by, for example, comparing the Peak Current Control Signal to a predetermined threshold), the converter reverts back to its normal operating state where the switching of the phase current is relying upon either a peak only limit or a valley only limit (not both.)

Yet another way to view the process described above, also in relation to the waveforms in FIG. 2, is that while switching of the phase current is not always synchronized to a clock signal (due to a changing load), the phase current can be described as being switched in accordance with a clock signal, for example a clock signal that defines a periodic ramp signal used by a PWM generator (this is also referred to here as the clock signal that controls the switching rate or switching frequency of the phase current.) The process for controlling average phase current then may be viewed as one in which the high side switch is closed in response to, or only if, the valley limit reached condition has been detected (during a downward excursion of the phase current) when a predetermined clock edge of a clock signal, that controls the switching rate of the phase current, is also detected. In one embodiment, the high side switch is closed in response to, or only if, the valley limit reached condition is detected (during the downward excursion of the phase current) at, or within a predetermined delay after a predetermined clock edge of the clock signal.

Thus, as seen in FIG. 2, the valley limit is not enforced when it is detected ahead of or just at the clock edge 15 (which means that the phase current is allowed to fall below the valley limit); but the valley limit is enforced when it is detected within a certain delay time after the clock edge has arrived (where FIG. 2 shows four consecutive switching cycles in which the valley limit is enforced just after the arrival of clock edges 16, 17, 18, 19.) Enforcing the valley limit means that the phase current is not allowed to fall below the valley limit, and in fact starts to rise due to the closing of the high side switch. As an example implementation, the SMPS controller 8 may include AND logic (not shown) having i) a first input coupled to receive a delayed output signal of the valley comparator 11 and ii) a second input to receive the clock signal, wherein an output of the AND logic is coupled to close the switch of the high side 5. The delay may be adjustable to control the relative timing needed to make the decision as to enforcing the valley limit.

Viewed another way, still referring to FIG. 2, in order for the switch in the low side to be opened, not only is the clock signal edge needed but also the valley comparator needs to indicate that the phase current is below the valley limit. If the clock signal edge is received while the phase current is too high, then the low side switch will remain closed until the phase current drops to the valley limit. Only then will the SMPS controller 8 be allowed to close the switch in the high side and begin charging the phase once again. Note however that with such an approach, the switching frequency of the phase current is no longer controlled once the peak limit is reached (and constant current ripple is being enforced.)

Referring back to FIG. 1, it was suggested above that the valley and peak limits may be variable programmable, to for example allow for an average current limit that could be set to different values, for example depending on the dc rating of the inductor of the phase 3. In another embodiment of the invention, the set peak and valley limits are varied dynamically, e.g., in response to detecting that a switching rate of the phase current is below a threshold or above a threshold, so that the set peak and valley limits are varied in a way that maintains as constant an average current limit of the phase current. The switching rate of the phase current may change due to for example the particular PWM control algorithm used, but in this case the average current limit remains fixed. Viewed another way, the SMPS controller 8 can vary the set peak and valley limits, as part of a set average current, based on an error signal that it computes, to meet an average current target with variable plus and minus offsets, wherein the variable offsets are being changed so as to maintain constant a switching rate of the phase current.

In still another embodiment, the set average current is an error signal-based limit that is produced based on detecting for example output voltage, output current, or both, of the dc-dc power converter, and that therefore varies as a function of the load. Referring to FIG. 2, a peak current control signal is shown that temporarily rises above the peak current limit, indicating that more, phase 3 current is being requested. Of course, the phase current does not follow that request as shown, because it is limited due to the fixed peak limit used by the peak comparator 9 (see FIG. 1.) which in part defines the set average current. In one embodiment, the set average current is an error signal-based average current limit that rises when the detected output voltage or the detected output current is below a threshold, and falls when the detected output voltage or the detected output current is above a threshold.

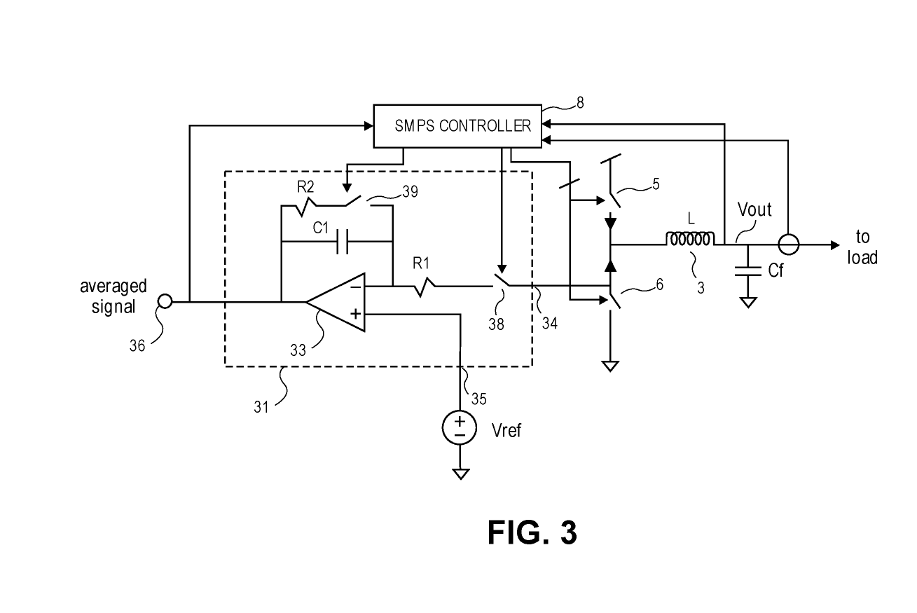

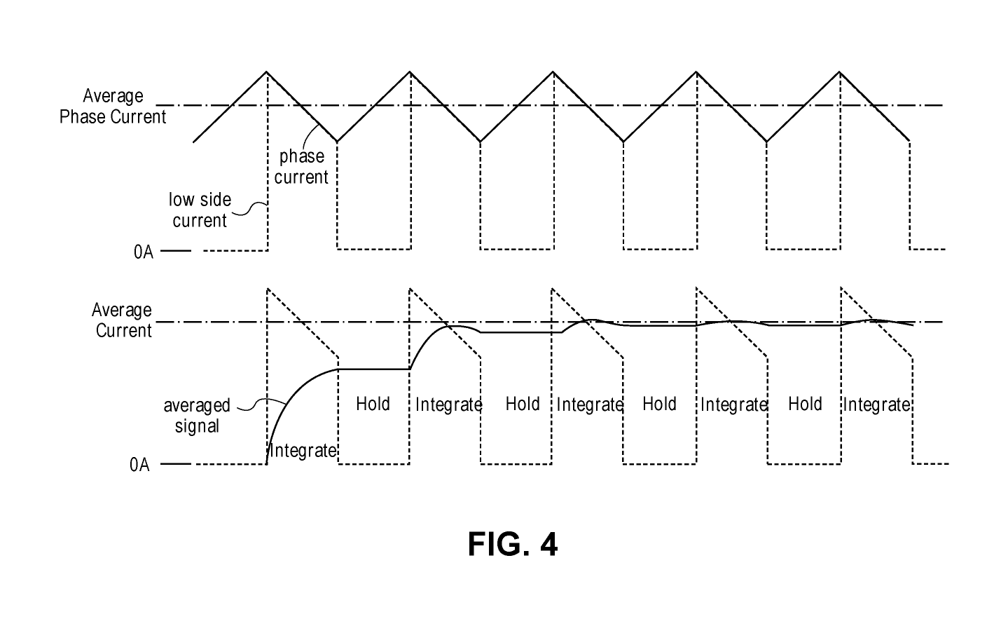

FIG. 3 is a combined block diagram and circuit schematic illustrating part of another dc-dc switching power converter that can perform a method for detecting an average of its switching phase current. Thus, rather than directly control the average current as in FIG. 1, the embodiment of FIG. 3 can produce a measure of the average current. The method may proceed as follows. A signal that represents current through a low side, or a high side, not both simultaneously, of a phase, is averaged. This is done while the low side, or the high side, is conducting phase current of the phase. This results in an averaged signal being produced. While doing so, the averaged signal is held constant while the low side, or the high side, is not conducting the phase current. To explain using an example, consider FIG. 4 whose top graph shows phase current, average phase current and low side current of a switching dc-dc power converter. The bottom graph shows an example of the averaged signal, in relation to the low side current. As seen before, the phase current is rising, then falling, then rising, then falling, etc. as a triangular waveform. The averaging is illustrated in the bottom graph, where a voltage drop, across a low side switch or across a low side sense resistor, is integrated, while the phase current is falling and not while the phase current is rising (because the averaged signal is being held while the phase current is rising.) In other words, the voltage is being integrated only when the low side is conducting the phase current, not when the high side is conducting the phase current, and the integrated signal is then held at whatever value it had when the high side starts to conduct. Simulations of the example circuit show in FIG. 3 and described below have confirmed the behavior depicted in the bottom graph of FIG. 4, where such an averaged signal, after only a handful of switching cycles, is an accurate estimate of the actual average phase current.

Referring back to FIG. 3, a schematic of a circuit for detecting average phase current of a dc-dc power converter (e.g., a buck converter) is shown. Briefly, when the phase current is rising, then falling, then rising, then falling, etc. as a triangular waveform, an integrator 31 averages a signal that represents current through the low side, by integrating a voltage drop across a low side switch or a low side sense resistor. This is done while the phase current is falling but not while the phase current is rising, since the averaged signal is being held constant during the latter intervals. Using a voltage reference circuit Vref whose output is coupled to a reference input of the integrator 31, wherein output of the voltage reference circuit sets voltage of the output of the integrator 31 that represents zero average current (in the low side), the averaged signal can thus be a quantitative measure of the average phase current. Note also that the circuit described below may be replicated, for one or more additional phases (in the case a multi-phase converter.)

The integrator 31 has a signal input 34, a reference input 35, an output 36, and a hold circuit. In this case, the integrator 31 and the reference voltage source Vref are designed such that the signal input 34 is to be coupled to sense a voltage of the low side 6 of the phase 3; an alternative here is to design the integrator 31 and Vref so that the signal input 34 is coupled to sense a voltage of the high side 5. In both instances, the hold circuit is controllable to configure the integrator 31 into i) an integrate state in which the signal input 34 is being integrated into an output signal (“averaged signal”) at the output 36, and ii) a hold state in which the signal input 34 is not being integrated and the output signal is held constant. The SMPS controller 8 signals the hold circuit so that the integrator 31 is configured into i) the integrate state while the low side 6 (or alternatively the high side 5, if a voltage drop in the latter is being sensed), is conducting phase current of the phase 3, and ii) the hold state while the low side 6 (or alternatively the high side 5) is not conducting the phase current. As evidenced by the simulation results shown in the bottom graph of FIG. 4, the averaged signal accurately gives a measure of the average phase current. Note here that the reference voltage source Vref may be used to set the voltage of the output of the integrator 31 that represents zero average current in the low side (or the high side.)

Still referring to FIG. 3, the integrator 31 in this example is implemented using an op amp-based voltage integrator that is based on an op amp 33 that is configured as an inverting integrator amplifier (due to the negative sensed voltage drop in the low side.) The integrator has a capacitor C1 that couples the inverting input to the output of the op amp, a resistor R2 to address non-idealities of the op amp, and resistor R1 that together with C1 sets a gain of the amplifier along with R2 and the integration time constant. These time constants may be chosen to optimize speed or accuracy, depending on the application requirements. In such an embodiment, the hold circuit comprises a first switch 38 that couples an inverting (negative) input of the op amp 33 to the low side 6 of the phase 3 or the near end of the phase 3 (while Vref is coupled to ground and sets the non-inverting input of the op amp 33 to a desired, positive voltage above ground that represents zero average current.) A second switch 39 is to break or make a feedback path that couples the inverting input of the op amp 33 to the output 36 (which is also the output of the op amp 33, in this case.) The SMPS controller 8 asserts an output control signal to open the first switch and the second switch 39 (stops integration and holds the voltage at the output 36), when an input control signal indicates that a switch in the low side is open, and de-asserts the output control signal to close the first and second switches (resumes integration) when the input control signal indicates that the low side switch is closed.

Another method for averaging a signal that represents current through the low side, or through the high side, is to generate the signal as an output current and then integrate the output current. The output current may be produced by a current sensing device, e.g., a Hall effect sensor, or by a current mirror circuit.

In one embodiment, the averaged signal obtained using the process above (and the example circuit in FIG. 3) is compared to a threshold, and in response on-times of the high side and low side are reduced, so as to prevent an average level of the switching phase current from exceeding a dc rated current of an inductor of the phase 3.

In another embodiment, the averaged signal is compared to an error signal that represents an output voltage error or an output current error for the converter. In response, on-times or off-times of the high side are controlled so as to reduce the error signal.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. For example, while the high and low sides of the phase 3 have been depicted as using solid state switches to conduct the phase current, it should be understood that in other embodiments the low side may be implemented using a diode and no switch, to conduct the phase current. The description is thus to be regarded as illustrative instead of limiting.

What is claimed is:

1. A method for dc-dc power conversion using a switching phase whose phase current is being switched to maintain an average level of the phase current, comprising:
while a high side switch of the phase is closed, detecting that a high side current of the phase has risen to a set peak limit, and in response opening the high side switch; and
maintaining the high side switch open so long as a valley limit reached condition has not been detected when a predetermined clock edge of a clock signal, that controls a switching rate of the phase current, is detected, wherein the valley limit reached condition is detected when a low side current of the phase has dropped to a set valley limit.

2. The method of claim 1 further comprising:
closing the high side switch in response to the valley limit reached condition being detected at, or within a predetermined delay after, a predetermined clock edge of the clock signal.

3. The method of claim 1 further comprising:
varying the set peak and valley limits in response to detecting that a switching rate of the phase current is below a threshold or above a threshold, in a way that maintains constant an average current limit of the phase current.

4. The method of claim 1 wherein an average current limit of the phase current is no more than 10% lower than a dc rated current of an inductor of the phase.

5. The method of claim 1 wherein an average current through the phase is no more than the average of the set peak limit and the set valley limit.

6. The method of claim 1 wherein the set peak limit and the set valley limit define a set average current that is an error signal-based average current limit that is produced based on detecting output voltage, output current, or both, of the dc-dc power conversion,
wherein the error signal-based average current limit rises when the detected output voltage or the detected output current is below a threshold, and falls when the detected output voltage or the detected output current is above a threshold.

7. The method of claim 1 further comprising:
varying the set peak and valley limits based on an error signal to meet an average current target with variable plus and minus offsets, wherein the variable plus and minus offsets are changed to maintain constant a switching rate of the phase current.

8. A switching dc-dc power converter comprising:
an input;
an output;
a phase having a near end and a far end, the far end being coupled to the output;
a high side switch that is coupled between the near end of the phase and the input; and
a first current detector configured to compare a high side current of the phase with a set peak limit, wherein an output of the first current detector is coupled to control opening of the high side switch; and
a second current detector configured to compare a low side current of the phase with a set valley limit and signal a valley limit reached condition; and
an SMPS controller that is coupled to open and close the high side switch, and while the high side switch is open prevent the high side switch from closing so long as the valley limit reached condition has not been signaled by the second current detector.

9. The dc-dc power converter of claim 8 wherein the SMPS controller is to open and close the high side switch in accordance with a clock signal, and further comprises:
AND logic having i) a first input coupled to receive a delayed output signal of the second current detector and ii) a second input to receive the clock signal, wherein an output of the AND logic is coupled to close the high side switch.

10. The dc-dc power converter of claim 8 wherein the SMPS controller is configured to vary the set peak and valley limits in response to detecting that a switching rate of the phase current is below a threshold or above a threshold, in a way that keeps unchanged an average of the phase current.

11. The dc-dc power converter of claim 8 wherein an average current limit of the phase current is no more than 10% lower than a dc rated current of an inductor of the phase.

12. The dc-dc power converter of claim 8 wherein an average current through the phase is no more than the average of the set peak limit and the set valley limit.

13. The dc-dc power converter of claim 8 wherein the set peak limit is an error signal-based peak limit that is produced based on detecting output voltage, output current, or both, of the dc-dc power converter,
and wherein the error signal-based peak limit rises when the detected output voltage or the detected output current is above a threshold, and falls when the detected output voltage or the detected output current is below a threshold.

14. The dc-dc power converter of claim 8 wherein the SMPS controller is to vary the set peak and valley limits based on an error signal, to meet an average current target with variable plus and minus offsets, wherein the variable plus and minus offsets are to be changed so as to maintain constant a switching rate of the phase current.

15. A method for detecting an average of a switching phase current in a dc-dc power converter, comprising:
a) averaging a signal that represents current through a low side, or a high side, of a phase, while the low side, or the high side, is conducting phase current of the phase, to produce an averaged signal; and
b) holding the averaged signal constant while the low side, or the high side, is not conducting the phase current.

16. The method of claim 15 wherein averaging the signal that represents current comprises:
integrating a voltage drop across a low side switch, while the low side is conducing the phase current.

17. The method of claim 15 wherein the phase current has a triangular waveform, and wherein averaging the signal that represents current comprises:
integrating a voltage drop across a low side switch or a low side sense resistor, while the phase current is falling and not while the phase current is rising.

18. The method of claim 15 further comprising:
comparing the averaged signal to a threshold and in response reducing on-times of the high side and low side so as to prevent an average level of the switching phase current from exceeding a dc rated current of an inductor of the phase.

19. The method of claim 15 wherein averaging the signal that represents current comprises
integrating the signal that represents current through the high side while the phase current is rising,
and wherein holding the averaged signal constant comprises holding the averaged signal constant while the phase current is falling.

20. The method of claim 15 further comprising:
comparing the averaged signal to an error signal that represents an output voltage error or an output current error for the power converter, and in response controlling on-times or off-times of the high side so as to reduce the error signal.

21. A circuit for detecting average phase current of a dc-dc power converter, comprising:
an integrator having a signal input, a reference input, an output, and a hold circuit, wherein the signal input is to be coupled to a low side or a high side, of a phase of a of dc-dc power converter, wherein the hold circuit is controllable to configure the integrator into i) an integrate state in which the signal input is being integrated into an output signal at the output, and ii) a hold state in which the signal input is not being integrated and the output signal is held constant; and
an SMPS controller that is configured to control the hold circuit so that the integrator is configured into i) the integrate state while the low side, or the high side, is conducting phase current of the phase, and ii) the hold state while the low side, or the high side, is not conducting the phase current.

22. The circuit of claim 21 wherein the integrator comprises an op amp-based voltage integrator, and the hold circuit comprises a first switch that couples an input of the op amp to the low side of the phase, and a second switch that is to break or make a feedback path that couples an input of the op amp to an output of the op amp.

23. The circuit of claim 22 wherein the SMPS controller is configured to assert an output control signal to open the first switch when an input control signal indicates that a low side switch in the low side is open, and de-asserts the output control signal to close the first switch when the input control signal indicates that the low side switch is closed.

24. The circuit of claim 21 further comprising a voltage reference source whose output is coupled to the reference input of the integrator, wherein output of the voltage reference source sets voltage of the output of the integrator that represents zero average current in the low side, or the high side.

25. The circuit of claim 21 further comprising a comparator that is to compare the output signal of the integrator to a reference, the comparator having an output that is coupled to control on-times of the high side, and wherein the reference represents an average current limit for the phase.
